(19) United States
(12) Patent Application Publication
(10) Pub. No.: US 2026/0319487 A1
(43) Pub. Date: Oct. 15, 2026

(54) ROBOT INCLUDING SENSOR UNIT CONFIGURED TO BE EXPANDIBLE AND RETRACTABLE AND METHOD OF CONTROLLING THE SAME

(71) Applicant: NAVER CORPORATION, Seongnam-si (KR)

(72) Inventors: Jaehun HAN, Seongnam-si (KR); Jung-eun KIM, Seongnam-si (KR); Minsu KIM, Seongnam-si (KR); Seunghwan CHUNG, Seongnam-si (KR)

(73) Assignee: NAVER CORPORATION, Seongnam-si (KR)

(21) Appl. No.: 19/466,997

(22) Filed: Feb. 2, 2026

Related U.S. Application Data
(63) Continuation of application No. PCT/KR2024/004605, filed on Apr. 8, 2024.

(30) Foreign Application Priority Data
Aug. 2, 2023 (KR) 10-2023-0101010

(51) Int. Cl. G05D 1/20; B25J 19/02; G05D 1/622; G05D 1/667; G05D 105/28; G05D 109/12

(52) U.S. Cl. CPC G05D 1/20; B25J 19/021; G05D 1/622; G05D 1/667; G05D 2105/28; G05D 2109/12

(57) ABSTRACT

Example embodiments are directed to a robot including a sensor unit configured to acquire sensing information on a surrounding environment and at a top of the robot, and a driving unit configured to drive the robot for autonomous driving of the robot based on the sensing information. The sensor unit is configured to be expandible or retractable based on a size of a payload loaded on the robot, and a detection range of the sensor unit for the surrounding environment varies as the sensor unit expands or retracts.

### CROSS-REFERENCE TO RELATED APPLICATION(S)

This U.S. non-provisional application is a continuation application of PCT International Application PCT/KR2024/004605, which has an international filing date of Apr. 8, 2024, and which claims priority under 35 U.S.C. § 119 to Korean Patent Application No. 10-2023-0101010, filed on Aug. 2, 2023, in the Korean Intellectual Property Office, the entire disclosures of which are herein incorporated by reference.

### BACKGROUND

Some example embodiments of the following description relate to a robot including a sensor unit and a driving unit, and a method of controlling the robot.

Robots, including autonomous robots, are being used to provide various services in indoor and outdoor spaces. Such a robot is configured to autonomously navigate within a space to perform a specific or given task and/or provide a service.

A robot may load an object (hereinafter, payload) inside to perform a given task and/or provide a service. In general, the robot may carry a payload of a limited size due to size constraint of the robot, and may not carry a payload that is larger than the size of the robot, for example, a relatively larger payload that may extend beyond the robot or protrude outward from the robot. When a relatively larger payload is loaded, the field of view (FOV) of a sensor included in the robot may be occluded. When the sensor of the robot may not secure or provide the sufficient FOV, the robot may not properly perform autonomous driving.

Therefore, it is beneficial to enable a robot to carry a relatively larger payload and include a sensor in the robot that may provide the sufficient FOV even when a relatively larger payload is loaded on the robot.

The information described above is only for the purpose of helping understanding, and may include content that does not form a portion of the art, and may not include what the art may present to one of ordinary skill in the art.

### SUMMARY

Some example embodiments may provide a robot that may have a suitable detection range of a sensor unit for autonomous driving of the robot by providing the sensor unit configured to acquire sensing information of a surrounding environment for autonomous driving of the robot at the top of the robot and by providing a driving unit configured to drive the robot for autonomous driving of the robot at the bottom of the robot.

Some example embodiments may provide a robot including a sensor unit that may recognize a payload loaded on the robot and may appropriately expand (or extend) or retract according to the size of the loaded payload.

Some example embodiments may provide a method of updating a driving path of a robot and controlling the robot to drive along the updated driving path in consideration of the collision radius of the robot that varies in response to expansion or retraction of a sensor unit.

According to some example embodiments, a robot is configured to autonomously drive in a space, and the robot includes a sensor unit configured to acquire sensing information on a surrounding environment for autonomous driving of the robot, and at a top of the robot; and a driving unit configured to drive the robot for autonomous driving of the robot based on the sensing information, wherein the sensor unit is configured to be expandible or retractable based on a size of a payload loaded on the robot, and a detection range of the sensor unit for the surrounding environment varies as the sensor unit expands or retracts.

The payload may be an object that is loaded in a storage space under the sensor unit of the robot, and the sensor unit may be configured to be controlled by a robot control system that controls the robot or may be configured to be controlled by the robot, the sensor unit being further configured to expand outward from the robot such that the detection range is not obscured by the payload, as the payload is recognized by the sensor unit.

The sensor unit may include at least one sensor configured to detect a front lower side of the robot, and unless a side of the payload is recognized by the at least one sensor, the sensor unit may be controlled to expand outward from the robot until the side of the payload is recognized.

The sensor unit may include at least one sensor configured to detect a front lower side of the robot, and unless a height of the robot corresponding to a value preset by the at least one sensor is measured, the sensor unit may be controlled to expand outward from the robot until the height of the robot corresponding to a preset value is measured.

The sensor unit may include at least one sensor configured to detect a front lower side of the robot, and unless a floor surface of the space is recognized by a preset level or more by the at least one sensor, the sensor unit may be configured to be controlled to expand outward from the robot until the floor surface of the space is recognized by the preset level or more.

The sensor unit may include at least one sensor configured to detect a front lower side of the robot, and unless a height of the robot corresponding to a value preset by the sensor is measured by the at least one sensor as a first condition, unless a side of the payload is recognized by the at least one sensor as a second condition, or unless a floor surface of the space is recognized by the at least one sensor by a preset level or more by the sensor as a third condition, the sensor unit may be configured to be controlled to expand outward from the robot until at least one of the first condition, the second condition or the third condition is satisfied.

The sensor unit may be configured to radially expand in a radial direction of the robot and to retract in an opposite direction, based on recognition of the payload.

The sensor unit may include a plurality of legs, and may include at least one sensor configured to detect a front lower side of the robot at an end side of each leg of the plurality of legs, and based on the recognition of the payload by the at least one sensor, each leg of the plurality of legs may be configured to expand in the radial direction of the robot and to retract in the opposite direction.

The sensor unit may include at least one sensor configured to detect a front lower side of the robot, and the at least one sensor may include at least one of a distance sensor configured to measure a distance to an object in the surrounding environment and an optical sensor configured to recognize a vision of the object.

The robot may be configured to be controlled to autonomously drive in the space based on a driving parameter that varies in response to expansion or retraction of the sensor unit, the driving parameter may be changed by operations performed by a robot control system that controls the robot or is changed by operations performed by the robot, and the operations may include identifying a change value indicating an expansion or retraction level of the sensor unit; calculating a changed collision radius and inertial information of the robot based on the change value; and changing the driving parameter based on the calculated collision radius and the inertial information.

The calculating may include converting the change value to a sensor displacement matrix associated with the robot; and calculating the changed collision radius based on the sensor displacement matrix and inertial measurement unit (IMU) sensing information from the sensor unit, and calculating the inertial information by applying the sensor displacement matrix and the IMU sensing information to an inertial model associated with the robot.

The robot may be configured to autonomously drive along a path within the space under control from a robot control system that controls the robot, and the robot control system is configured to, identify a changed collision radius of the robot that varies in response an expansion or a retraction of the sensor unit, update the path based on the changed collision radius, and autonomously drive the robot based on the updated path.

An update of the path may be performed while the robot is autonomously driving, in response to the changed collision radius of the robot further increasing in response to the expansion of the sensor unit, the path may be updated to include an area in which the robot is capable of driving, and in response to the changed collision radius of the robot further decreasing in response to the retraction of the sensor unit, the path may be updated to include an area in which the robot is capable of reaching a destination more quickly.

The sensor unit may include a plurality of sensors configured to detect a front lower side of the robot, and the detection range may correspond to a field of view (FOV) of each sensor of the plurality of sensors.

According to some example embodiments, a robot control method may be performed by a robot that moves within a space or a robot control system that controls the robot, wherein the robot includes a sensor unit configured to acquire sensing information on a surrounding environment for autonomous driving of the robot, and at a top of the robot; and a driving unit configured to drive the robot for autonomous driving of the robot based on the sensing information, and the robot control method may include expanding or retracting the sensor unit based on a size of a payload loaded on the robot, a detection range of the sensor unit for the surrounding environment varying in response to an expansion or a retraction of the sensor unit; and controlling the autonomous driving of the robot based on the sensing information acquired by an expanded or retracted sensor unit.

The sensor unit may include at least one sensor configured to detect a front lower side of the robot, and the expanding or the retracting of the sensor unit may include unless a side of the payload is recognized by the at least one sensor, expanding the sensor unit outward from the robot until the side of the payload is recognized; unless a height of the robot corresponding to a value preset by the at least one sensor is measured by the at least one sensor, expanding the sensor unit outward from the robot until the height of the robot corresponding to the preset value is measured; or unless a floor surface of the space is recognized by a preset level or more by the at least one sensor, expanding the sensor unit outward from the robot until the floor surface of the space is recognized by the preset level or more.

The sensor unit may include the at least one sensor configured to detect the front lower side of the robot, and the expanding or the retracting of the sensor unit may include unless the height of the robot corresponding to the value preset by the at least one sensor is measured by the at least one sensor as a first condition, unless the side of the payload is recognized by the at least one sensor as a second condition, or unless the floor surface of the space is recognized by the at least one sensor by the preset level or more by the at least one sensor as a third condition, expanding the sensor unit outward from the robot until at least one of the first condition, the second condition, or the third condition is satisfied.

The controlling of the autonomous driving may include controlling autonomous driving of the robot based on a driving parameter that varies in response to the expansion or the retraction of the sensor unit, and the controlling of the autonomous driving may include identifying a change value indicating an expansion level or a retraction level of the sensor unit; calculating a changed collision radius and inertial information of the robot based on the change value; and changing the driving parameter based on the calculated changed collision radius and the inertial information.

The controlling of the autonomous driving may include controlling autonomous driving of the robot that follows a path within the space, and the controlling of the autonomous driving may include identifying a changed collision radius of the robot that varies in response to the expansion or the retraction of the sensor unit; updating the path based on the changed collision radius, and controlling the autonomous driving of the robot based on the updated path.

According to some example embodiments, by providing a sensor unit configured to acquire sensing information of a surrounding environment for autonomous driving of a robot at the top of the robot, it is possible to provide the autonomous driving robot in an environment that enables the robot to more effectively acquire information (e.g., cliff detection) on the floor surface on which the robot autonomously drives.

According to some example embodiments, by implementing a robot including a sensor unit that is appropriately expandable and retractable according to the size of a recognized payload, it is possible to load a larger payload that protrudes from the outer perimeter of the robot and to allow autonomous driving of the robot without being hindered although the larger payload is loaded.

According to some example embodiments, by dynamically updating a driving path of a robot in consideration of the collision radius of the robot that varies in response to expansion or retraction of a sensor unit, it is possible to control the robot to autonomously drive along an optimal driving path. Therefore, it is possible to dynamically control the robot to avoid an area through which the robot may not pass as the sensor unit expands, and to drive a ‘smaller dedicated path’ through which the robot may drive as the sensor unit retracts.

Further areas of applicability will become apparent from the description provided herein. The description and examples in this summary are intended for purposes of illustration only and are not intended to limit the scope of the present disclosure.

### BRIEF DESCRIPTION OF DRAWINGS

FIG. 1A illustrates a robot including a sensor unit configured to expand or retract based on a size of a payload loaded on the robot and a control method thereof according to some example embodiments.

FIG. 1B illustrates a robot including an autonomous driving module including a sensor unit, a service module, and a driving platform according to some example embodiments.

FIG. 1C illustrates a robot with a sensor at a lower portion of the robot.

FIG. 2 is a block diagram illustrating a robot that moves within a space according to some example embodiments.

FIGS. 3 and 4 are block diagrams illustrating a robot control system that controls a robot according to some example embodiments.

FIG. 5 is a flowchart illustrating a method of controlling a robot including a sensor unit configured to be expandible and retractable based on a size of a payload loaded on the robot according to some example embodiments.

FIGS. 6 and 9 are flowcharts illustrating a method of controlling a sensor unit of a robot to expand or retract according to some example embodiments.

FIGS. 7 and 10 are flowcharts illustrating a method of changing a driving parameter of a robot in response to expansion or retraction of a sensor unit of the robot according to some example embodiments.

FIGS. 8 and 11 are flowcharts illustrating a method of controlling autonomous driving of a robot in consideration of the collision radius of the robot that varies in response to expansion or retraction of a sensor unit of the robot according to some example embodiments.

FIGS. 12 and 13 illustrate a sensor unit configured to be expandible or retractable based on a size of a payload loaded on a robot according to some example embodiments.

FIGS. 14A and 14B illustrate the detection range of a sensor unit provided at the top of a robot according to some example embodiments.

### DETAILED DESCRIPTION

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

Hereinafter, example embodiments will be described in detail with reference to the accompanying drawings.

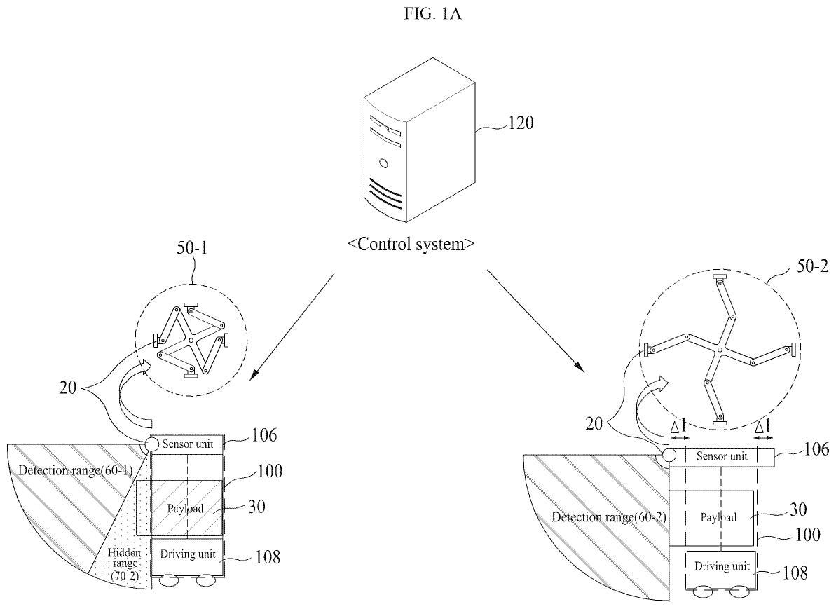

FIG. 1A illustrates a robot including a sensor unit configured to expand or retract based on a size of a payload loaded on the robot and a control method thereof according to some example embodiments. FIG. 1B illustrates a robot including an autonomous driving module including a sensor unit, a service module, and a driving platform according to some example embodiments.

FIGS. 1A and 1B illustrate a robot 100 in which a sensor unit 106 is provided at the top of the robot 100.

FIG. 1C illustrates a robot with a sensor at a lower portion of the robot. For example, FIG. 1C illustrates a robot 70 in which a sensor unit (and a sensor 72 included in the sensor unit) is provided at or adjacent the lower portion.

The robot 100 illustrated in FIGS. 1A and 1B may drive within a space or area. The robot 100 may be configured to provide a service in, for example, an indoor space such as a building or an outdoor space. For the purposes of discussion herein, the robot 100 refers to any type of transportation or moving object that drives (or autonomously drives) in an indoor or an outdoor space, such as a vehicle or a cart. As illustrated, the robot 100 may move within the space under control of a (robot) control system 120.

The space in which the robot 100 moves (or drives) refers to a space in which the robot 100 provides a service, and may represent, for example, a building or an indoor/outdoor space included in the building. The building includes a space in which a plurality of persons (hereinafter, users) work or reside, and may include, for example, a plurality of partitioned spaces. The space represents a portion (specific floor or partial space within a corresponding floor) of the building.

When the robot 100 is a service robot, the robot 100 may be configured to provide a service on at least one floor of the space. Although FIG. 1A illustrates only a single robot 100, a plurality of robots 100 may be deployed and operate within the space. Each of the robots 100 may move within the space and may provide a service at an appropriate or desired location or to an appropriate or desired user.

A service provided by the robot 100 may include, for example, at least one of a parcel delivery service, a beverage (coffee, etc.) delivery service according to an order, a cleaning service, and other information/content provision services.

The robot 100 may be configured to provide a service at a predetermined or desired location within the space or to a predetermined user through autonomous driving Movement and service provision of (each) robot 100 may be controlled by the robot control system 120.

As illustrated, the robot 100 may include a sensor unit 106 and a driving unit 108. The sensor unit 106 may be provided at the top (or upper portion) of the robot 100, and the driving unit 108 may be provided at the bottom (or lower portion) of the robot 100. The sensor unit 106 may be configured to acquire sensing information on a surrounding environment within the space for autonomous driving of the robot 100 within the space. The sensor unit 106 may include at least one sensor 20. As illustrated, the sensor 20 may be configured to at least detect the front lower side of the robot 100. Also, the sensor 20 may be configured to detect the surrounding environment or the vicinity (including the upper side) at the top of the robot 100.

To enable the robot 100 to avoid obstacles and to autonomously drive, the sensor unit 106 may include the sensor 20 that is configured to detect the surrounding environment or vicinity of the robot 100 and a computing module associated with the sensor 20. As illustrated in FIG. 1B, a module configured by including the sensor 20 and the computing module may be referred to as an autonomous driving module 12. The robot 100 of some example embodiments may include this autonomous driving module 12 at the top of the robot 100.

The driving unit 108 may be a device that drives the robot 100 for autonomous driving of the robot 100 based on the sensing information from the sensor unit 106. The driving unit 108 may control movement of the robot 100, and may include equipment for performing the movement as a component that enables the movement. The driving unit 108 may include at least one motor, a motor driver, and other mechanisms such as an electronic and/or mechanical device that operates for driving of the robot 100. For example, wheels of the robot 100 may operate by the motor, and the robot 100 may drive in the space. Also, the driving unit 108 may include a battery for operating the robot 100.

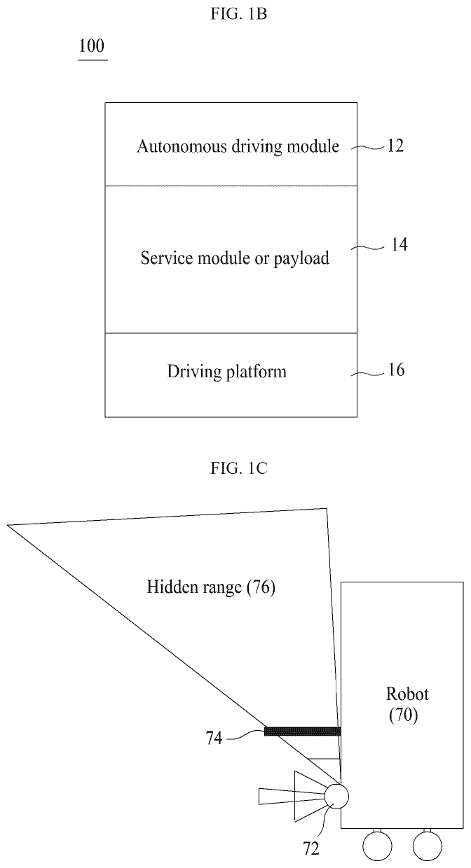

The driving unit 108 is a component that is provided at the bottom of the robot 100, including devices related to driving of the robot 100, and may be referred to as a driving platform 16 as in FIG. 1B. In some example embodiments, the driving unit 108 and the driving platform 16 may correspond to an actuator 110, which is described below with reference to FIG. 2.

The robot 100 may have a structure in which the sensor unit 106 is provided at the top of the robot 100 and the driving unit 108 is provided at the bottom of the robot 100, and a payload 30 is loaded between the sensor unit 106 and the driving unit 108.

The payload 30 may represent a cargo or an object that is loaded and stored on the robot 100, and may be, for example, food, a parcel, a cleaning supply, or trash that a cleaning robot grasps, related to a service provided from the robot 100. The payload 30 may have various shapes and sizes. The payload 30 may represent an object that is loaded in a storage space under the sensor unit 106 of the robot 100.

Referring to FIG. 1B, the robot 100 may provide the space for loading the payload 30 between the autonomous driving module 12 and the driving platform 16. A component of the robot 100 that includes this space may be referred to as a service module 14. The service module 14 may further include a mechanism (e.g., other hardware having a specific function, such as a robot arm) for loading the payload 30 onto the robot 100, in addition to the space (storage space) in which the payload 30 is loaded.

In some example embodiments, since the sensor unit 106 is provided at the top of the robot 100, information on the surrounding environment required for autonomous driving (for example, information on the floor surface of the space) may be more effectively detected compared to the robot 70 (FIG. 1C) in which the sensor 72 is provided at the bottom of the robot 70. For example, compared to the robot 70, the robot 100 may more effectively detect curves, ledges, cliffs, etc., present on the floor surface of the space, and may more easily identify dynamic and/or static obstacles present on the floor surface.

Meanwhile, in the robot 70, when a protruding portion 74 is present due to a payload loaded on the robot 70, the detection range of the sensor 72 may be limited. For example, as illustrated, a hidden range 76 may be present in the detection range of the sensor 72. In this hidden range 76, it is challenging to detect information on the surrounding environment, so the robot 70 may not be appropriately controlled for autonomous driving. Also, in the case of the robot 70, an additional near distance sensor may be used to detect the floor surface or a cliff in front, and it is challenging to maintain and repair the robot 70 and keep the bottom including the sensor 72 clean.

The robot 100, according to some example embodiments, may include the sensor unit 106 configured to be expandible (or extendable) and retractable based on a size of the payload 30 loaded on the robot 100, to obtain a sufficient or desired detection range 60-2 of the sensor 20. This detection range of the sensor unit 106 for the surrounding environment may vary as the sensor unit 106 expands (extends) or retracts.

For example, as illustrated in FIG. 1A, in a retracted state 50-1, the detection range of the sensor unit 106 (e.g., detection range 60-1 of sensor 20 included in sensor unit 106) may be limited due to a hidden range 70-2 covered by the protruding payload 30. In contrast, in an expanded state 50-2, a range covered (or hidden) by the protruding payload 30 may be reduced and thus, the detection range of the sensor unit 106 (e.g., detection range 60-2 of sensor 20) may be improved. In some example embodiments, the sensor unit 106 of the robot 100 may expand (or extend) by a certain change value (Δl) according to the size of the payload 30, and as the sensor unit 106 expands, the detection range of the sensor 20 may be changed (e.g., detection range 60-1->detection range 60-2).

In some example embodiments, as the payload 30 is recognized by the sensor unit 106, the robot control system 120 that controls the robot 100 may control the sensor unit 106 to expand outward (or extend) from the robot 100 such that the detection range of the sensor 20 is not obscured by the payload 30.

In this way, the robot 100, according to some example embodiments, may safely and autonomously drive within the space even when the payload 30 with a larger size that protrudes beyond the outer perimeter of the robot 100 is loaded or although the payloads 30 of various sizes or shapes are loaded.

As illustrated, the sensor unit 106 may expand (or extend) outward in all directions when the payload 30 protrudes from the robot 100, even if the payload 30 protrudes only from a portion of the outer perimeter of the robot 100 (see FIG. 1A). However, in some example embodiments, the sensor unit 106 may be controlled to expand only from the side of the payload 30 that extends beyond the outer perimeter of the robot 100. In some example embodiments, the sensor unit 106 may be controlled to expand from the side of the payload 30 that extends beyond the outer perimeter of the robot 100 and from one or more sides of the payload 30 adjacent (e.g., immediately adjacent) to the side of the payload 30 that extends beyond the outer perimeter of the robot 100.

For example, the sensor unit 106 may expand outward only in response to a protruding portion when the payload 30 protrudes from the robot 100. For example, as illustrated in FIG. 1A, when the payload 30 protrudes only in one direction (e.g., front side) of the robot 100, the sensor unit 106 may be controlled to expand only in response to that one direction. For example, a sensor portion provided on the opposite side (rear side) of the sensor 20 of the sensor unit 106 may not expand outward since the payload 30 does not protrude to the rear side. In this way, when the sensor unit 106 includes a plurality of sensors, a portion corresponding to each sensor may be individually controlled for its expansion and/or retraction according to the size and shape of the payload 30 loaded on the robot 100.

In some example embodiments, by providing the intelligently variable sensor unit 106 (e.g., autonomous driving module 12) at the top of the robot 100, the constraints on the service module 14 and the payload 30 provided below the sensor unit 106 may be mitigated. Therefore, it is possible to load the payload 30 on the robot 100, which is not restricted by the shape (e.g., cylindrical shape) and/or size of the robot 100.

Also, autonomous driving of the robot 100 may be adaptively controlled by considering the variable sensor unit 106 (e.g., considering the loaded payload 30).

Therefore, in some example embodiments, although the payload 30 larger than the robot 100 is loaded on the robot 100, a collision probability between the payload 30 and an obstacle may be reduced.

A method of expanding (or extending) or retracting the sensor unit 106 based on the size of the payload 30 loaded on the robot 100 is further described with reference to FIGS. 2 to 14B.

FIG. 2 is a block diagram illustrating a robot that moves within a space according to some example embodiments.

As described above, the robot 100 may be a service robot used to provide a service within the space. The robot 100 may provide a service at a predetermined location within the space or to a predetermined user through autonomous driving.

The robot 100 may be a physical device and, as illustrated, may include a controller 104, the actuator 110, the sensor unit 106, and a communication unit 102.

The controller 104 may be a physical processor embedded in the robot 100 and, although not separately illustrated, may include a path planning processing module, a mapping processing module, a driving control module, a localization processing module, a data processing module, and a service processing module. Here, the path planning processing module, the mapping processing module, and the localization processing module may be included in the controller 104 depending on example embodiments, to enable indoor autonomous driving of the robot 100 even when communication with the robot control system 120 is not performed. At least a portion of the controller 104 may be included in the autonomous driving module 12 provided at the top of the robot 100 described above.

The communication unit 102 may be a component that allows the robot 100 to communicate with another device (another robot/robot control system 120). The communication unit 102 may be a hardware module such as an antenna, a data bus, a network interface card, a network interface chip, and a networking interface port of the robot 100, or a software module such as a network device driver or a networking program, which transmits/receives data and/or information to and from the other device.

The actuator 110 may include equipment for performing movement of the robot 100 as a component that controls and enables the movement of the robot 100. The actuator 110 may include at least one motor as an electronic and/or mechanical device that operates for driving of the robot 100. For example, wheels of the robot 100 may operate by the motor, and the robot 100 may drive in the space. The actuator 110 may be a component corresponding to the aforementioned driving unit 108, and may be a component included in the driving platform 16 provided at the bottom of the robot 100.

The sensor unit 106 may be a component for collecting data required for autonomous driving and service provision of the robot 100. The sensor unit 106 may include at least one sensor 20 as a component corresponding to the sensor unit 106 described above with reference to FIG. 1A. The sensor unit 106 may be included in the aforementioned autonomous driving module 12, and may include a computing module corresponding to at least one of the aforementioned controller 104.

The sensor unit 106 may include a sensor such as an ultrasonic sensor and/or a camera. The sensor unit 106 may include a sensor for identifying another robot or person in front and/or behind and an obstacle in the surroundings (floor within space). For example, the sensor unit 106 may include at least one of a depth camera, an infrared (IR) camera or sensor, a vision sensor (optical sensor for vision recognition) such as a red, green, blue (RGB) camera, and a distance sensor as the sensor 20. Through this sensor 20, the other robot, person, and other objects present around, or the payload 30 loaded on the robot 100 may be recognized. The sensor 20 may have a relatively higher resolution and higher capacity or capability to acquire information on the surrounding environment.

The robot 100 may receive an instruction that is received by the service processing module of the controller 104 through the robot control system 120, through the communication unit 102 or the communication unit 102 and the data processing module, and may operate the actuator 110 and the robot arm for service provision. The service processing module may deliver a drive instruction for a service to be provided to the driving control module, and the driving control module may control components included in the actuator 110 and the robot arm of the robot 100 in response to the drive instruction, such that the service may be provided. Also, the robot 100 may further include a speaker and/or display for outputting information/content required to provide a service.

The robot 100 may be distinguished from a robot for mapping (e.g., a mapping robot) used to generate an indoor map within the space. Since the robot 100 does not include relatively expensive sensing equipment, indoor autonomous driving may be processed using an output value of a sensor, such as a low-cost ultrasonic sensor and/or a low-cost camera. Meanwhile, if the robot 100 has processed indoor autonomous driving through communication with the robot control system 120, the robot 100 may enable relatively more accurate indoor autonomous driving while using low-cost sensors by further utilizing mapping data included in path data (e.g., path-related data) received from the robot control system 120. However, depending on example embodiments, the robot 100 may also serve as a mapping robot.

As described above, the robot 100 may provide sensing information for controlling the robot 100 to the robot control system 120. When an algorithm for controlling the robot 100 is executed in the robot control system 120, the robot 100 may correspond to a brainless robot.

Meanwhile, each robot 100 may have a different size and shape depending on a robot type or a service to be provided, which is not limited to the illustrated shape.

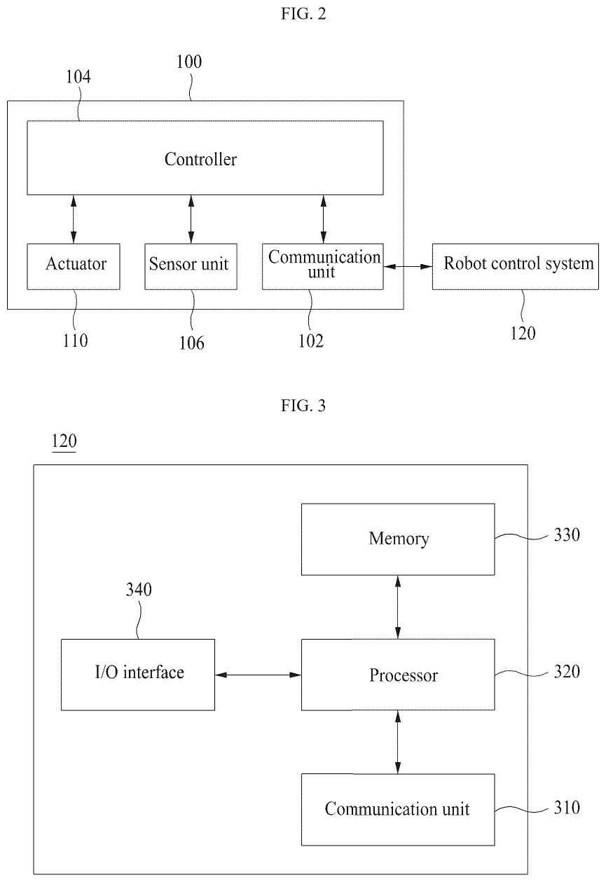

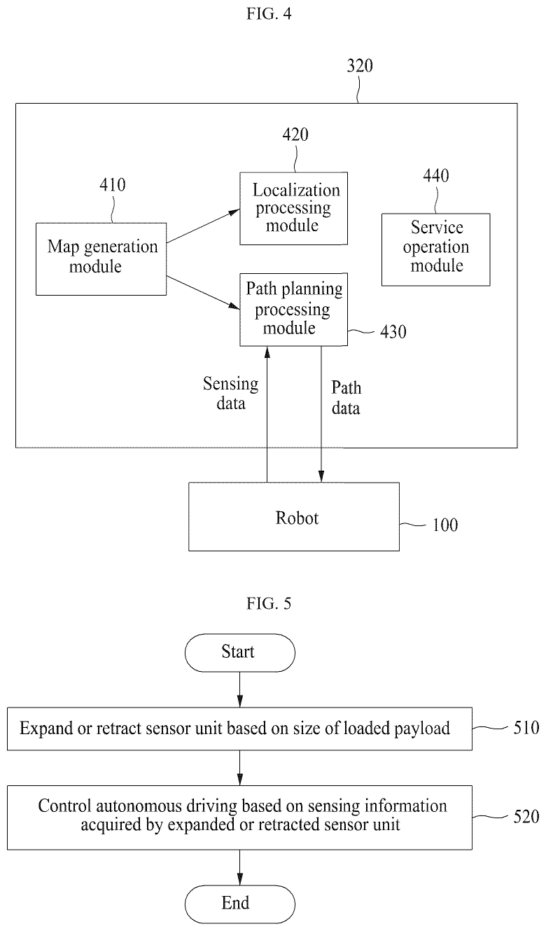

The configuration and operation of the robot control system 120 that controls the robot 100 are further described with reference to FIGS. 3 and 4.

Description related to technical features described above with reference to FIGS. 1A-1C may be applicable to FIG. 2, so redundant description is omitted for the sake of brevity.

FIGS. 3 and 4 are block diagrams illustrating a robot control system for controlling a robot according to some example embodiments.

The robot control system 120 may be a device that controls the operation of components of the robot 100 (e.g., the above-described expanding and contracting operation of the sensor unit 106) for movement (e.g., autonomous driving) of the robot 100 within the space and provision of a service within the space. The robot control system 120 may control movement of each of the plurality of robots 100 and service provision of each of the robots 100. The robot control system 120 may set up a path to a destination for the robot 100 to provide a service through communication with the robot 100, and may transmit information on the path to the robot 100. The robot 100 may drive according to the received information on the path, and may control the arm at a predetermined location or at a location of a predetermined user to provide a service.

The robot control system 120 may include at least one computing device.

As described above, the robot control system 120 may be a device that sets up (or maps or otherwise configures) a path for driving of the robot 100 and controls the movement of the robot 100 along the path. The robot control system 120 may include at least one computing device, and may be implemented as a server that is present inside or outside the space that includes the robot 100.

Referring to FIG. 3, the robot control system 120 may include a memory 330, a processor 320, a communication unit 310, and an input/output (I/O) interface 340.

The memory 330 may include a permanent mass storage device, such as a random access memory (RAM), a read only memory (ROM), and a disk drive, as a computer-readable recording medium. Here, the permanent mass storage device such as ROM may be included as a permanent storage device separate from the memory 330. Also, an operating system (OS) and at least one program code may be stored in the memory 330. Such software components may be loaded from another computer-readable recording medium separate from the memory 330. The other computer-readable recording medium may include a computer-readable recording medium, for example, a floppy drive, a disk, a tape, a DVD/CD-ROM drive, and a memory card. In another example embodiment, software components may be loaded to the memory 330 through the communication unit 310, instead of the computer-readable recording medium.

The processor 320 may be configured to process an instruction of a computer program by performing basic arithmetic, logic, and I/O operations. The instruction may be provided from the memory 330 or the communication unit 310 to the processor 320. For example, the processor 320 may be configured to execute the received instructions in response to the program code loaded to the memory 330. The processor 320 may include components (410 to 440) illustrated in FIG. 4.

Each of the components (410 to 440) of the processor 320 may be a software module and/or a hardware module as a portion of the processor 320, and may represent a function or an operation implemented by the processor 320. The components (410 to 440) of the processor 320 are described below with reference to FIG. 4.

The communication unit 310 may be a component for the robot control system 120 to communicate with another device (robot 100 or another server). That is, the communication unit 310 may be a hardware module such as an antenna, a data bus, a network interface card, a network interface chip, and a networking interface port of the robot control system 120, or a software module such as a network device driver or a networking program, which transmits and receives data and/or information to and from the other device.

The I/O interface 340 may be a method for interfacing with an input device, such as a keyboard and a mouse, and an output device, such as a display and a speaker.

Also, in some example embodiments, the robot control system 120 may include a greater number of components than the illustrated components.

The components (410 to 440) of the processor 320 are further described with reference to FIG. 4. As illustrated, the processor 320 may include a map generation module 410, a localization processing module 420, a path planning processing module 430, and a service operation module 440. The components included in the processor 320 may be representations of different functions or operations performed by at least one processor included in the processor 320 in response to a control instruction according to a code of at least one program or a code of an operating system (OS).

The map generation module 410 may be a component for a mapping robot autonomously driving inside the space to generate an indoor map of a target facility (e.g., using sensing information generated for the inside of the space).

Here, the localization processing module 420 may determine a location of the robot 100 inside the target facility using sensing information received from the robot 100 through a network and the indoor map of the target facility generated through the map generation module 410.

The path planning processing module 430 may generate a control signal for controlling indoor autonomous driving of the robot 100 using the sensing information received from the robot 100 and the generated indoor map. For example, the path planning processing module 430 may generate a path (e.g., path data) of the robot 100. The generated path data may be set for the robot 100 for driving of the robot 100 that follows the corresponding path. The robot control system 120 may transmit information on the generated path to the robot 100 through the network. For example, information on the path may include information indicating a current location of the robot 100, information for mapping the current location and the indoor map, and/or path planning information.

Information on the path may include information on a destination of the space in which the robot 100 needs to drive in order to provide a service at a predetermined location within the space or to a predetermined user. The path planning processing module 430 may set the path for the robot 100 with respect to the robot 100. The robot control system 120 may control movement of the robot 100 such that the robot 100 may move along the set path.

The service operation module 440 may include a function for controlling a service that the robot 100 provides within the space. For example, a service provider that operates the robot control system 120 or the space may provide an integrated development environment (IDE) for a service (e.g., cloud service) that the robot control system 120 provides to a user or a manufacturer of the robot 100. Here, the user or the manufacturer of the robot 100 may create software for controlling the service that the robot 100 provides within the space through the IDE, and may register the same to the robot control system 120. In this case, the service operation module 440 may control the service provided by the robot 100 using software registered in association with the corresponding robot 100. For example, assuming that the robot 100 provides a service of delivering the payload (e.g., food or package) 30 requested by the user to a location of the corresponding user, the robot control system 120 may control indoor autonomous driving of the robot 100 such that the robot 100 moves to a location of the user, and may also deliver a related instruction to the robot 100 such that the robot 100 provides a series of services of delivering an item to the user by controlling a robot arm when arriving at a destination location, and outputting a voice response to the user.

The robot control system 120 may be a server as a computer system for controlling the robot 100. The robot control system 120 may be a cloud server as a server provided outside a space or a building. Alternatively, in some example embodiments, the robot control system 120 may be provided inside the space or the building.

In the following description, actions performed by components (e.g., controller, processor) of the robot control system 120 or the robot 100 may be described as actions performed by the robot control system 120 or the robot 100, for convenience of description.

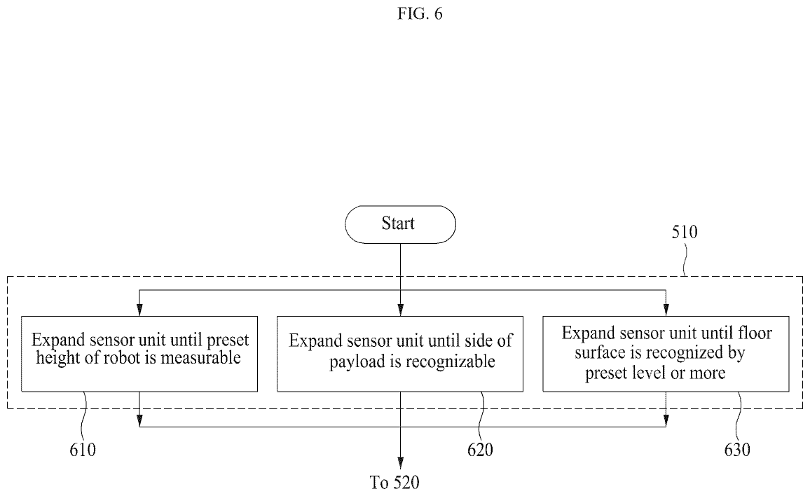

Also, actions or operations including controlling of the sensor unit 106 described below with reference to FIGS. 5 to 14B may be performed by the robot control system 120. Depending on example embodiments, at least some thereof may be performed by the robot 100. Hereinafter, example embodiments are described based on actions or operations performed by the robot control system 120, and overlapping description related to actions or operations performed by the robot 100 may be omitted.

Description related to technical features described above with reference to FIGS. 1A, 1B, 1C, and 2 may be applicable to FIG. 5, so redundant description is omitted.

FIG. 5 is a flowchart illustrating a method of controlling a robot including a sensor unit configured to be expandible (or extendable) and retractable based on a size of a payload loaded on the robot according to some example embodiments. It is understood that additional operations can be provided before, during, and after the operations in FIG. 5, and some of the operations described below can be replaced or eliminated, for additional embodiments of the method. The order of the operations/processes may be interchangeable, or two or more operations can be performed simultaneously.

As described above with reference to FIG. 1A, the robot 100 may include the sensor unit 106 (or autonomous driving module 12) configured to acquire sensing information on the surrounding environment for autonomous driving and provided at the top of the robot 100, and the driving unit 108 (or driving platform 16) configured to drive the robot 100 for autonomous driving of the robot 100 based on sensing information by the sensor unit 106. The sensor unit 106 may include at least one sensor 20 configured to detect the front lower side of the robot 100.

In operation 510, the robot 100 may expand or retract the sensor unit 106 based on the size of the payload 30 loaded on the robot 100. The robot control system 120 may control the robot 100 to expand or retract the sensor unit 106 based on the size of the payload 30. The detection range of the sensor unit 106 for the surrounding environment may vary as the sensor unit 106 expands or retracts.

In operation 520, the robot control system 120 may control autonomous driving of the robot 100 based on the sensing information acquired by the sensor unit 106 expanded or retracted through operation 510. As the sensor unit 106 expands or retracts, the detection range of the sensor 20 included in the sensor unit 106 may vary and accordingly, the sensing information acquired by the sensor unit 106 may also change. The robot control system 120 may change a driving parameter for controlling autonomous driving of the robot 100 based on the changed sensing information and may further update a path through which the robot 100 may drive.

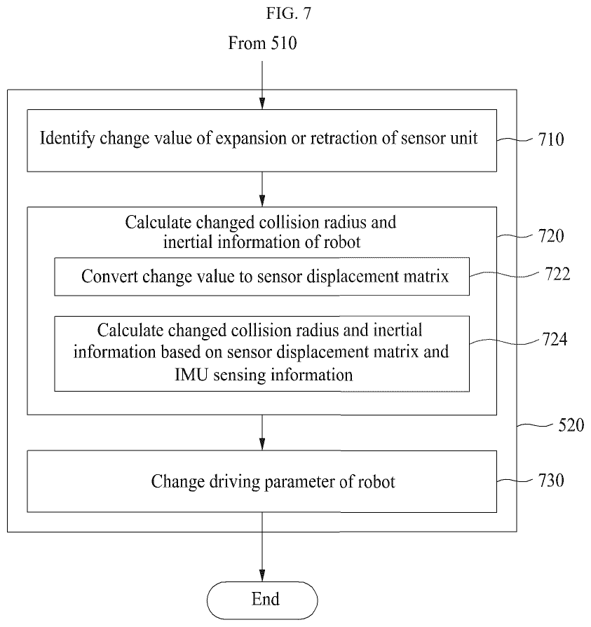

A method of controlling the robot 100 to expand or retract the sensor unit 106 based on the size of the payload 30 is further described with reference to FIGS. 6 to 11.

Description related to technical features described above with reference to FIGS. 1 to 4 may be applicable to FIG. 6, so redundant description is omitted for the sake of brevity.

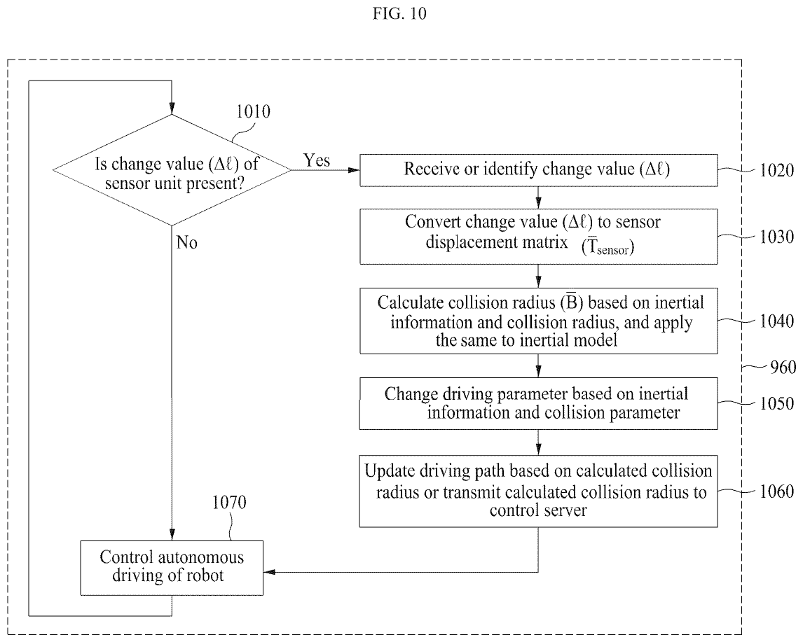

FIGS. 6 and 9 are flowcharts illustrating a method of controlling a sensor unit of a robot to expand or retract according to some example embodiments. It is understood that additional operations can be provided before, during, and after the operations in FIGS. 6 and 9, and some of the operations described below can be replaced or eliminated, for additional embodiments of the method. The order of the operations/processes may be interchangeable, or two or more operations can be performed simultaneously.

As described above, the sensor unit 106 may include at least one sensor 20 configured to detect the front lower side of the robot 100. This sensor 20 may be positioned below the sensor unit 106, and may recognize the payload 30 that protrudes outward from the perimeter of the robot 100.

In operation 610, the robot control system 120 may determine whether the height of the robot 100 corresponding to a value preset by the sensor 20 is measured, and when the height of the robot 100 corresponding to the preset (or desired or given) value is not measured, for example, when the measured height is less than the height of the robot 100 corresponding to the preset value, the robot control system 120 may expand the sensor unit 106 outward from the robot 100 until the measured height reaches the height of the robot 100 corresponding to the preset value. Here, the sensor 20 may include a distance sensor. The ‘preset value’ corresponding to the height of the robot 100 refers to a known value, so it may be a value already known to the robot 100 and/or the robot control system 120. In a state in which the distance to the floor surface of the space is measurable by the sensor 20, the measured distance to the floor surface may be equal to the height of the robot 100 corresponding to the preset value. In contrast, when the payload 30 is protruded, the height of the robot 100 corresponding to the value set by the sensor 20 may not be measured, and the distance from the sensor 20 to the payload 30 may be measured. In this case, the detection range of the sensor 20 may be limited by the aforementioned hidden range 70-2. The robot control system 120 may control the robot 100 to expand the sensor unit 106 such that the detection range of the sensor 20 is not limited.

In operation 620, the robot control system 120 may determine whether the side of the payload 30 is recognized by the sensor 20, and when the side of the payload 30 is not recognized, for example, when only the top surface of the payload 30 is recognized, may expand the sensor unit 106 outward from the robot 100 until the side of the payload 30 is recognized. Here, the sensor 20 may include an optical sensor, such as a camera. For example, the sensor 20 may have a detection range (or FOV of camera) exceeding 90 degrees. Accordingly, although the payload 30 is protruded, the sensor 20 may recognize the side of the payload 30 in the expanded state 50-2 of FIG. 1A. In a state in which the side of the payload 30 is recognized, the detection range of the sensor 20 may not be limited. In contrast, in a state in which the side of the payload 30 is not recognized, the detection range of the sensor 20 may be limited by the hidden range 70-2. Therefore, the robot control system 120 may control the robot 100 to expand the sensor unit 106 such that the detection range of the sensor 20 is not limited.

Meanwhile, an object perception algorithm may be executed for recognition of the payload 30 by the sensor 20. For example, the robot control system 120 may determine whether the side of the payload 30 is recognized by the sensor 20 using the results of learning various types and shapes of the payload 30 through the object perception algorithm.

In operation 630, the robot control system 120 may determine whether the floor surface of the space is recognized by the sensor 20 by a preset level or more, and when the floor surface of the space is not recognized by the preset level or more, for example, when the floor surface of the space covered by the payload 30 is not recognized by the preset level or more, may expand the sensor unit 106 outward from the robot 100 until the floor surface of the space is recognized by the preset level or more. Here, the sensor 20 may include an optical sensor, such as a camera. For example, when the payload 30 is protruded, the sensor 20 may not sufficiently (or desirably) recognize the floor surface of the space due to the protruding portion of the payload 30, and the detection range of the sensor 20 may be limited by the hidden range 70-2 that is covered by the payload 30. Therefore, the robot control system 120 may control the robot 100 to expand the sensor unit 106 such that the detection range of the sensor 20 is not limited. For the purposes of discussion herein, ‘the floor surface is recognized by the preset level or more’ may indicate that ‘the floor surface is recognized by a predetermined ratio or more’ compared to a case in which the detection range of the sensor 20 is not limited.

When determining whether the floor surface is recognized by the sensor 20 by the preset level or more, a segmentation algorithm may be used. For example, the robot control system 120 may distinguishably recognize the floor surface of the space using the segmentation algorithm, and may determine whether the recognized floor surface corresponds to the preset level or more.

Operations 610 to 630 described above may be combined to determine whether expansion of the sensor unit 106 is required, and may be used to control the robot 100 to expand the sensor unit 106.

For example, referring to FIG. 9, when the height of the robot 100 corresponding to a value preset by the sensor 20 is not measured as a first condition (operation 910), when the side of the payload 30 is not recognized as a second condition (operation 920), or when the floor surface of the space is not recognized by the predetermined level or more by the sensor 20 as a third condition (operation 930), the robot control system 120 may control the robot 100 to expand the sensor unit 106 (operation 940).

Here, the robot control system 120 may expand the sensor unit 106 outward from the robot 100 until at least one of the first condition to the third condition is satisfied, and if at least one of the first condition to the third condition is satisfied, may complete settings of the sensor unit 106 (operation 950).

In this way, the robot control system 120 (or robot 100), according to some example embodiments, may expand the sensor unit 106 to ensure that the detection range of the sensor 20 is not limited, using various conditions, such as the first to third conditions.

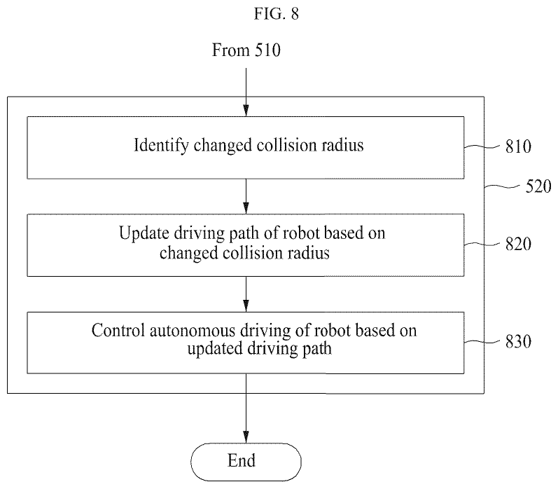

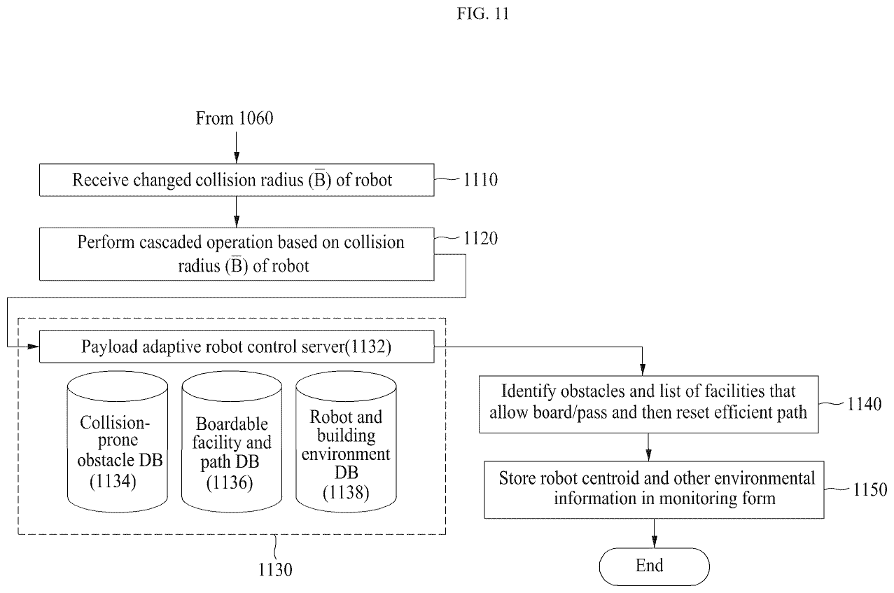

When settings of the sensor unit 106 are completed, the robot control system 120 may control autonomous driving of the robot 100 based on a change value (Δl) of the sensor unit 106 in operation 960. A method of controlling autonomous driving of the robot 100 based on the change value (Δl) of the sensor unit 106 is further described with reference to FIGS. 7 and 10.

In this regard, FIGS. 7 and 10 are flowcharts illustrating a method of changing a driving parameter of a robot in response to expansion or retraction of a sensor unit of the robot according to some example embodiments. It is understood that additional operations can be provided before, during, and after the operations in FIGS. 7 and 10, and some of the operations described below can be replaced or eliminated, for additional embodiments of the method. The order of the operations/processes may be interchangeable, or two or more operations can be performed simultaneously.

A driving parameter of the robot 100 may be changed as the sensor unit 106 expands or retracts. For example, considering that the sensor unit 106 expands or retracts may indicate that sensors including a camera of the robot 100 are transitioned in an expanded or retracted direction. Accordingly, the driving parameter of the robot 100 may be changed. The robot 100 may be controlled to autonomously drive within the space based on the changed driving parameter. For example, the changed driving parameter may reflect the sensor unit 106 (autonomous driving module 12) of the changed size.

Operations 710 to 730 and operations 1010 to 1070 described below may represent a method of changing the driving parameter(s) of the robot 100 and controlling autonomous driving of the robot 100 by way of the robot control system 120 that controls the robot 100 or the robot 100.

In operation 710, the robot control system 120 may identify a change value (Δl) indicating a degree to which the sensor unit 106 is expanded or retracted. For example, the robot control system 120 may determine whether the change value (Δl) of the sensor unit 106 is present (operation 1010), and may receive the change value (Δl) from the robot 100 or may identify the same (operation 1020).

In operation 720, the robot control system 120 may calculate the changed collision radius and inertial information of the robot 100 based on the identified change value (Δl). For example, as the sensor unit 106 expands, the collision radius of the robot 100 may further increase and inertial information according to driving of the robot 100 may also vary. The robot control system 120 may calculate the collision radius and the inertial information of the robot 100 according to the change of the sensor unit 106. The inertial information may include, for example, centroid information of the robot 100 changed according to the change in the sensor unit 106 of the robot 100.

In operation 722, the robot control system 120 may convert the identified change value (Δl) to a sensor displacement matrix (\ddot{T}ₛₑₙₛₒᵣ) associated with the robot 100 (operation 1030).

In operation 724, the robot control system 120 may calculate the changed collision radius (B̅) based on the sensor displacement matrix and inertial measurement unit (IMU) sensing information from the sensor unit 106, and may calculate the inertial information of the robot 100 by applying the sensor displacement matrix and the IMU sensing information to an inertial model associated with the robot 100 (operation 1040). The IMU sensing information may be a value acquired or calculated by at least one sensor among an acceleration sensor, a gyroscope, and an electromagnetic sensor included in the sensor unit 106.

In operation 730, the robot control system 120 may change the driving parameter of the robot 100 based on the calculated collision radius (B̅) and inertial information. The robot control system 120 may correct the driving parameter(s) of the robot 100 in consideration of acceleration/deceleration of the robot 100 by the calculated collision radius (B̅) and inertial information (operation 1050). Based on the inertial information, the inertia by the payload 30 (and/or changed sensor unit 106) while driving of the robot 100 may be corrected and reflected to the driving parameter. Correction of the driving parameter by correction of this inertia may relate to modeling the centroid of the robot 100 based on the IMU sensing information and to applying the same to the driving parameter.

The robot control system 120 may control autonomous driving of the robot 100 based on the changed driving parameter (operation 1070).

Meanwhile, the calculated collision radius (B̅) may be used to update a driving path through which the robot 100 drives and, to this end, may be used by the robot control system 120. Also, the calculated collision radius (B̅) may be transmitted to a separate control server and utilized (operation 1070).

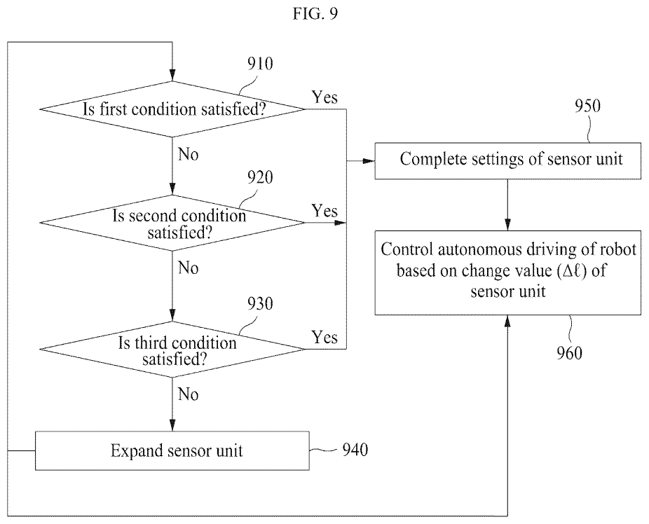

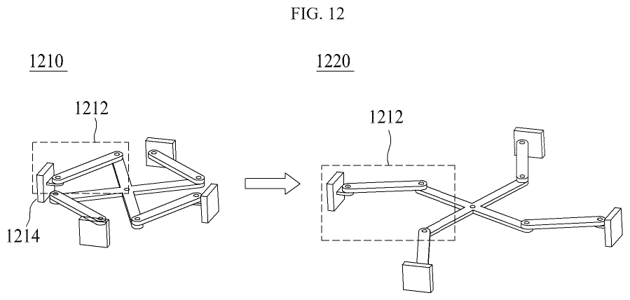

A method of updating the driving path of the robot 100 based on the calculated collision radius (B̅) and a method of utilizing the calculated collision radius (B̅) are further described with reference to FIGS. 8 and 11.

FIGS. 8 and 11 are flowcharts illustrating a method of controlling autonomous driving of a robot in consideration of the collision radius of the robot that varies in response to expansion or retraction of a sensor unit of the robot according to some example embodiments. It is understood that additional operations can be provided before, during, and after the operations in FIGS. 8 and 11, and some of the operations described below can be replaced or eliminated, for additional embodiments of the method. The order of the operations/processes may be interchangeable, or two or more operations can be performed simultaneously.

The robot 100 may be controlled to autonomously drive along a path within the space. The path may be a driving path of the robot 100 to a predetermined destination (e.g., destination or waypoint related to a service provided by the robot 100). The driving path (hereinafter, path) of the robot 100 may be determined by the robot control system 120, and may be dynamically updated by the robot control system 120.

In operation 810, the robot control system 120 may identify the changed collision radius (B̅) of the robot 100 as the sensor unit 106 expands or retracts. For example, the robot control system 120 may recognize or monitor the change in the collision radius according to expansion or retraction of the sensor unit 106.

In operation 820, the robot control system 120 may update the path through which the robot 100 drives based on this changed collision radius.

Update of the path may be dynamically performed while the robot 100 autonomously drives. For example, update of the path may be dynamically performed in response to the change in the payload 30 loaded on the robot 100, for example, in response to the change in the size of the payload 30 loaded on the robot 100.

For example, if the changed collision radius of the robot 100 further increases in response to expansion of the sensor unit 106, the driving path of the robot 100 may be updated to include an area in which the robot 100 may drive. As the collision radius of the robot 100 further increases, a narrow area (passage) through which the robot 100 may not pass may be excluded from the driving path of the robot 100. A relatively wider area in which the robot 100 may drive (e.g., an entrance, wide passage, and large freight elevator with a large gate through which the robot 100 may pass) may be included in the driving path of the robot 100.

Alternatively, if the changed collision radius of the robot 100 further decreases in response to retraction of the sensor unit 106, the driving path of the robot 100 may be updated to include an area that allows the robot 100 to more quickly reach the destination. For example, the driving path of the robot 100 may be updated to include an area through which the relatively small robot 100 may pass and a smaller passenger elevator.

In operation 830, the robot control system 120 may control autonomous driving of the robot 100 based on the updated path.

As such, the robot control system 120 may operate as a control server (system) that dynamically updates the path of the robot 100. The robot control system 120 may determine whether the robot 100 may drive on the existing path in consideration of the collision radius of the robot 100 that varies in response to settings of the sensor unit 106 and accordingly, may update the path and may transmit the updated path to the robot 100.

Therefore, although the sensor unit 106 expands, it is possible to preemptively reduce the risk of collision of the robot 100 and to improve the efficiency of autonomous driving of the robot 100. Also, a user that operates the robot 100 does not need to worry about the size of the payload 30 and the path of the robot 100, and the robot control system 120 may determine the optimal path for the robot 100. Accordingly, in some example embodiments, the incidence of human error may be reduced.

In some example embodiments, the robot control system 120 may monitor the size of the payload 30 in real time, so the robot control system 120 may control the robot 100 to drive on a smaller dedicated path when the size of the payload 30 is smaller, and may adaptively update the path of the robot 100 when a change occurs during driving, such as when the payload 30 is loaded on the robot 100 or unloaded from the robot 100. As a result, depending on the change in the payload 30, correction of a driving algorithm associated with the robot 100 and search for a target area in which the robot 100 may drive may be dynamically performed.

Hereinafter, an operation of a control server (or robot control system 120) using the changed collision radius (B̅) of the robot 100 is further described with reference to FIG. 11.

In operation 1110, the robot control system 120 (or separate control server) may receive the changed collision radius (B̅) of the robot 100. In operations 1120 and 1130, the robot control system 120 may perform an operation based on the collision radius (B̅) by referring to databases (1134 to 1138). Here, the robot control system 120 refers to a control server, and may also be referred to as a payload adaptive robot control server 1132. The control server 1132 may include a collision-prone obstacle database (DB) 1134, a boardable facility and path DB 1136, and a robot and building environment DB 1138, or may be configured to communicate with these DBs 1134 to 1138. These DBs (1134 to 1138) may store information collected from the space (e.g., by a mapping robot). The robot control system 120 may perform an operation for updating the path of the robot 100 through a cascaded operation based on the collision radius (B̅) that references information stored in these DBs (1134 to 1138). In operation 1140, the robot control system 120 may identify obstacles to the robot 100 and facilities and passages within the space that the robot 100 may board and pass through based on the collision radius (B̅) by referring to the DBs (1134 to 1138), and may update the path for the robot 100 based on the identified facilities and passages.

Meanwhile, in operation 1150, the robot control system 120 may store information collected from the robot 100 (e.g., sensing information, collision radius (B̅), centroid information of robot 100, and other environmental information). This stored information refers to traceable monitoring information for the robot 100, and may be utilized as data for maintaining the robot 100 or equipment within the space.

Description related to technical features described above with reference to FIGS. 1 to 5 may be applicable to FIGS. 6 to 11, so redundant description is omitted for the sake of brevity.

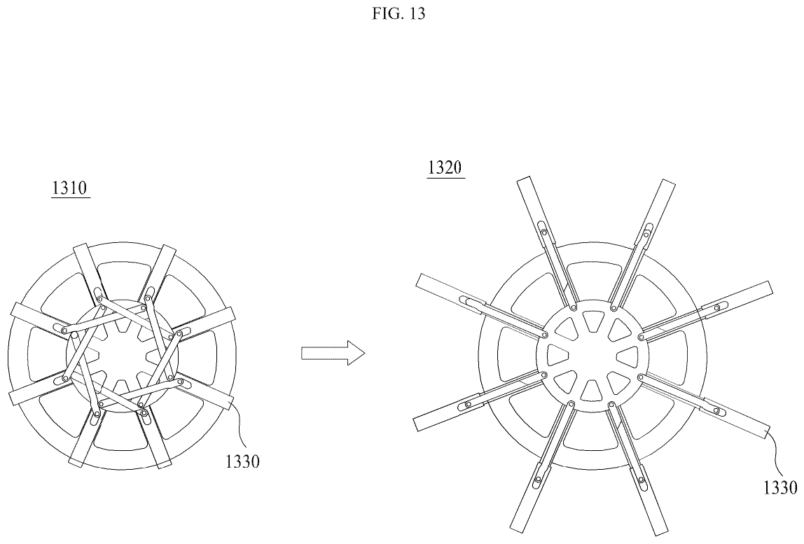

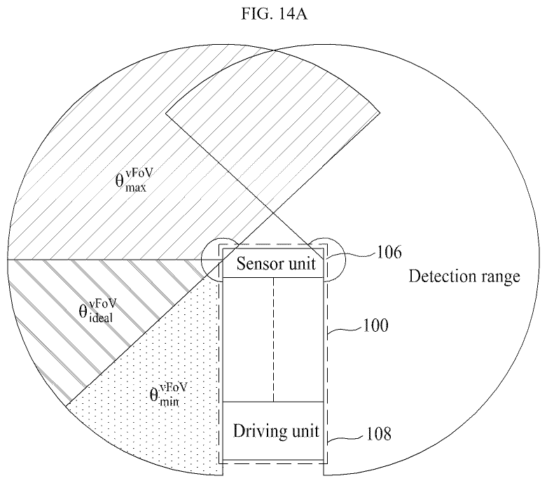

FIGS. 12 and 13 illustrate a sensor unit configured to be expandible (or extendable) or retractable based on a size of a payload loaded on a robot according to some example embodiments.

FIG. 12 illustrates a retracted state 1210 and an expanded state 1220 of the sensor unit 106 according to some example embodiments.

As illustrated, the sensor unit 106 may be configured to radially expand (or extend) in the radial direction of the robot 100 (e.g., expanded state 1220) and to retract in the opposite direction (e.g., retracted state 1210) based on recognition of the payload 30.

The sensor unit 106 may include a plurality of legs 1212 (alternatively, also referred to as arms). In the example illustrated in FIG. 12, the sensor unit 106 includes four legs 1212.

At least one sensor 1214 configured to detect the front lower side of the robot 100 may be included at the end of each of the legs 1212. Each of the legs 1212 may be retracted or expanded to change the detection range of the sensor 1214.

The sensor 1214 may include at least one of a distance sensor for measuring the distance (from robot 100 or sensor 1214) to an object present in the surrounding environment, and an optical sensor for vision recognition of the object.

Based on recognition of the payload 30 by the sensor 1214, each of the legs 1212 may be configured to radially expand in the radial direction of the robot 100 and also to retract in the opposite direction. For example, the legs 1212 may be configured to expand in a manner similar to an umbrella opening, and may also be configured to retract conversely.

Expansion and retraction of the legs 1212 may be performed by the controller 104 of the robot 100 or the robot control system 120. Expansion and retraction of the legs 1212 may be performed by an action of at least one actuator, or motor, which is performed or controlled by the controller 104 of the robot 100 or the robot control system 120.

Meanwhile, the legs 1212 may be controlled to collectively expand and retract. Depending on example embodiments, each of the legs 1212 may be controlled to individually expand and retract. For example, as described above with reference to FIG. 1A, when the payload 30 protrudes only in one direction (e.g., front side) of the robot 100, only a first leg corresponding to the one direction among the legs 1212 may be controlled to expand. If the payload 30 does not protrude from under the remaining legs 1212 other than the first leg, the corresponding remaining legs 1212 may not expand outward. In this way, when the sensor unit 106 is configured to include a plurality of sensors 1214 and legs 1212, the leg 1212 corresponding to each sensor 1214 may be controlled to individually expand and/or retract depending on the size and the shape of the payload 30 loaded on the robot 100.

FIG. 13 illustrates a retracted state 1310 and an expanded state 1320 of the sensor unit 106 according to some example embodiments. A sensor 1330 may be provided at the end of each leg. In the retracted state 1310, the sensor 1330 attached to each leg may not protrude from the outer perimeter of the robot 100. However, in the expanded state 1320, the sensor 1330 attached to each leg may protrude from the outer perimeter of the robot 100. Therefore, although the payload 30 protrudes from the outer perimeter of the robot 100, the detection range of the sensor 1330 may not be limited.

Unlike in FIG. 12, FIG. 13 illustrates some example embodiments in which eight legs are included in the sensor unit 106. However, the number of legs may vary depending on the detection range or performance of the sensor 1330.

Description related to technical features described above with reference to FIGS. 1 to 11 may be applicable to FIGS. 12 and 13, so redundant description is omitted for the sake of brevity.

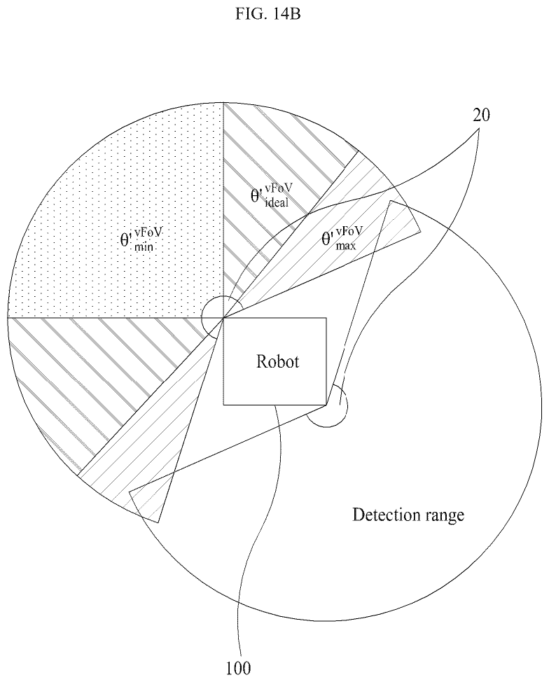

FIGS. 14A and 14B illustrates the detection range of a sensor unit provided at the top of a robot according to some example embodiments.

FIG. 14A is a side view illustrating the detection range of the sensor included in the sensor unit 106 of the robot 100. FIG. 14B is a top view illustrating the detection range of the sensor included in the sensor unit 106 of the robot 100.

As illustrated, the sensor unit 106 may include a plurality of sensors 20 configured to detect the front lower side of the robot 100. Also, each of the sensors 20 may be configured to detect the surrounding environment at the top of the robot 100 (including the top side thereof).

The detection range of each of the sensors 20 may correspond to the FOV of each of the sensors 20.

The number of sensors 20 provided to the sensor unit 106 may vary depending on the detection range of each of the sensors 20.

As illustrated in FIGS. 14A and 14B, each sensor 20 may have a detection range, such as the minimum range

$$( {θ}_{min}^{vFoV} , {θ}_{min}^{′ hFoV} ) ,$$

the ideal range

$$( {θ}_{ideal}^{vFoV} , {θ}_{ideal}^{′ hFoV} ) ,$$

or the maximum range

$$( {θ}_{max}^{vFoV} , {θ}_{max}^{′ hFoV} ) .$$

Here, the minimum range may be the detection range of the sensor 20 that enables the robot 100 to avoid obstacles while limiting collision during driving of the robot 100. In the minimum range, the sensor 20 may detect a cliff or edge on the floor surface. For example, this minimum range may be 90 degrees or less based on the top view, and may be 45 degrees based on the side view. The ideal range may be the detection range of the sensor 20 required to recognize an object in front of the robot 100 and to perform various functions of the robot 100. For example, the ideal range may be 90 degrees (or about 90 degrees) or more and 180 degrees (or about 180 degrees) or less based on the top view, and may be 45 degrees (or about 45 degrees) or more and 90 degrees (or about 90 degrees) or less based on the side view. The maximum range may be the detection range of the sensor 20 that enables detection in an upper area of the robot 100 and an upper interaction for the sensor unit 106. For example, the maximum range may be 180 degrees (or about 180 degrees) or more and 270 degrees (or about 270 degrees) or less based on the top view, and may be 90 degrees (or about 90 degrees) or more and 270 degrees (or about 270 degrees) or less based on the side view.

The arrangement and the number of sensors 20 may be determined to satisfy the minimum range, the ideal range, or the maximum range.

Description related to technical features described above with reference to FIGS. 1A to 13 may be applicable to FIGS. 14A and 14B, so redundant description is omitted for the sake of brevity.

The systems or the apparatuses described above may be implemented using hardware components, software components, and/or combination of hardware components and software components. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or transiently embodied in any type of machine, component, physical equipment, virtual equipment, a computer storage medium or device, or in a propagated signal wave capable of providing instructions or data to or being interpreted by the processing device. The software also may be distributed over network coupled computer devices so that the software is stored and executed in a distributed fashion. The software and data may be stored by one or more computer-readable storage mediums.

The methods according to some example embodiments may be configured in a form of program instructions performed through various computer methods and recorded in non-transitory computer-readable media. The computer-readable media may include, alone or in combination with program instructions, data files and data structures. The program instructions recorded in the media may be specially designed and configured for the example embodiments, or may be known and available to those in the computer software art. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of the program instructions include an advanced language code executable by a computer using an interpreter, as well as a machine language code as produced by a compiler.

Any or all of the elements described with reference to FIG. 4 may communicate with any or all other elements described with reference to FIG. 4. For example, any element may engage in one-way and/or two-way and/or broadcast communication with any or all other elements in any of the figures, to transfer and/or exchange and/or receive information such as but not limited to data and/or commands, such as in a serial and/or parallel manner, via a bus such as a wireless and/or a wired bus. The information may be in encoded in various formats, such as in an analog format and/or in a digital format, without being limited thereto.

As described herein, any devices, systems, modules, portions, units, controllers, circuits, and/or portions thereof according to any of the example embodiments, and/or any portions thereof (including, without limitation, the autonomous driving module 12, the service module 14, the driving platform 16, the robot 100, the control system 120, the sensor unit 106, the driving unit 108, the controller 104, the actuator 110, the sensor unit 106, the communication unit 102, the memory 330, the processor 320, the communication unit 310, the input/output (I/O) interface 340, the map generation module 410, the localization processing module 420, the path planning processing module 430, the service operation module 440, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a System-on-Chip (SoC), a programmable logic unit, a microprocessor, an application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments. The processing circuitry may include electrical components such as at least one of transistors, resistors, capacitors, etc. The processing circuitry may include electrical components such as logic gates including at least one of AND gates, OR gates, NAND gates, NOT gates, etc.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A robot configured to autonomously drive in a space, the robot comprising:
a sensor unit configured to acquire sensing information on a surrounding environment for autonomous driving of the robot, and at a top of the robot; and
a driving unit configured to drive the robot for autonomous driving of the robot based on the sensing information,
wherein the sensor unit is configured to be expandible or retractable based on a size of a payload loaded on the robot, and
a detection range of the sensor unit for the surrounding environment varies as the sensor unit expands or retracts.

2. The robot of claim 1, wherein the payload is an object that is loaded in a storage space under the sensor unit of the robot, and
the sensor unit is configured to be controlled by a robot control system that controls the robot or is configured to be controlled by the robot, the sensor unit being further configured to expand outward from the robot such that the detection range is not obscured by the payload, as the payload is recognized by the sensor unit.

3. The robot of claim 2, wherein the sensor unit includes at least one sensor configured to detect a front lower side of the robot, and
unless a side of the payload is recognized by the at least one sensor, the sensor unit is configured to be controlled to expand outward from the robot until the side of the payload is recognized.

4. The robot of claim 2, wherein the sensor unit includes at least one sensor configured to detect a front lower side of the robot, and
unless a height of the robot corresponding to a value preset by the at least one sensor is measured, the sensor unit is configured to be controlled to expand outward from the robot until the height of the robot corresponding to a preset value is measured.

5. The robot of claim 2, wherein the sensor unit includes at least one sensor configured to detect a front lower side of the robot, and
unless a floor surface of the space is recognized by a preset level or more by the at least one sensor, the sensor unit is configured to be controlled to expand outward from the robot until the floor surface of the space is recognized by the preset level or more.

6. The robot of claim 2, wherein the sensor unit includes at least one sensor configured to detect a front lower side of the robot, and
unless a height of the robot corresponding to a value preset by the at least one sensor is measured by the at least one sensor as a first condition,
unless a side of the payload is recognized by the at least one sensor as a second condition, or
unless a floor surface of the space is recognized by the at least one sensor by a preset level or more by the at least one sensor as a third condition,
the sensor unit is configured to be controlled to expand outward from the robot until at least one of the first condition, the second condition or the third condition is satisfied.

7. The robot of claim 1, wherein the sensor unit is configured to radially expand in a radial direction of the robot and to retract in an opposite direction based on recognition of the payload.

8. The robot of claim 7, wherein the sensor unit includes a plurality of legs, and includes at least one sensor configured to detect a front lower side of the robot at an end side of each leg of the plurality of legs, and
based on the recognition of the payload by the at least one sensor, each leg of the plurality of legs is configured to expand in the radial direction of the robot and to retract in the opposite direction.

9. The robot of claim 1, wherein the sensor unit includes at least one sensor configured to detect a front lower side of the robot, and
the at least one sensor includes at least one of a distance sensor configured to measure a distance to an object in the surrounding environment and an optical sensor configured to recognize a vision of the object.

10. The robot of claim 1, wherein the robot is configured to be controlled to autonomously drive in the space based on a driving parameter that varies in response to expansion or retraction of the sensor unit,
the driving parameter is changed by operations performed by a robot control system that controls the robot or is changed by operations performed by the robot, and
the operations comprise,
identifying a change value indicating an expansion or retraction level of the sensor unit;
calculating a changed collision radius and inertial information of the robot based on the change value; and
changing the driving parameter based on the calculated collision radius and the inertial information.

11. The robot of claim 10, wherein the calculating comprises:
converting the change value to a sensor displacement matrix associated with the robot; and
calculating the changed collision radius based on the sensor displacement matrix and inertial measurement unit (IMU) sensing information from the sensor unit, and calculating the inertial information by applying the sensor displacement matrix and the IMU sensing information to an inertial model associated with the robot.

12. The robot of claim 1, wherein the robot is configured to autonomously drive along a path within the space under control from a robot control system that controls the robot, and
the robot control system is configured to,
identify a changed collision radius of the robot that varies in response to an expansion or a retraction of the sensor unit,
update the path based on the changed collision radius, and
autonomously drive the robot based on the updated path.

13. The robot of claim 12, wherein an update of the path is performed while the robot is autonomously driving,
in response to the changed collision radius of the robot further increasing in response to the expansion of the sensor unit, the path is updated to include an area in which the robot is capable of driving, and
in response to the changed collision radius of the robot further decreasing in response to the retraction of the sensor unit, the path is updated to include an area in which the robot is capable of reaching a destination more quickly.

14. The robot of claim 1, wherein the sensor unit includes a plurality of sensors configured to detect a front lower side of the robot, and
the detection range corresponds to a field of view (FOV) of each sensor of the plurality of sensors.

15. A robot control method performed by a robot that moves within a space or a robot control system that controls the robot, wherein
the robot comprises,
a sensor unit configured to acquire sensing information on a surrounding environment for autonomous driving of the robot, and at a top of the robot; and
a driving unit configured to drive the robot for autonomous driving of the robot based on the sensing information, and
the robot control method comprises,
expanding or retracting the sensor unit based on a size of a payload loaded on the robot, a detection range of the sensor unit for the surrounding environment varying in response to an expansion or a retraction of the sensor unit; and
controlling the autonomous driving of the robot based on the sensing information acquired by an expanded or retracted sensor unit.

16. The robot control method of claim 15, wherein the sensor unit includes at least one sensor configured to detect a front lower side of the robot, and
the expanding or the retracting of the sensor unit comprises,
unless a side of the payload is recognized by the at least one sensor, expanding the sensor unit outward from the robot until the side of the payload is recognized;
unless a height of the robot corresponding to a value preset by the at least one sensor is measured by the at least one sensor, expanding the sensor unit outward from the robot until the height of the robot corresponding to the preset value is measured; or
unless a floor surface of the space is recognized by a preset level or more by the at least one sensor,
expanding the sensor unit outward from the robot until the floor surface of the space is recognized by the preset level or more.

17. The robot control method of claim 16, wherein the sensor unit includes the at least one sensor configured to detect the front lower side of the robot, and
the expanding or the retracting of the sensor unit comprises,
unless the height of the robot corresponding to the value preset by the at least one sensor is measured by the at least one sensor as a first condition,
unless the side of the payload is recognized by the at least one sensor as a second condition, or
unless the floor surface of the space is recognized by the at least one sensor by the preset level or more by the at least one sensor as a third condition,
expanding the sensor unit outward from the robot until at least one of the first condition, the second condition, or the third condition is satisfied.

18. The robot control method of claim 16, wherein the controlling of the autonomous driving comprises controlling autonomous driving of the robot based on a driving parameter that varies in response to the expansion or the retraction of the sensor unit, and
the controlling of the autonomous driving comprises,
identifying a change value indicating an expansion level or a retraction level of the sensor unit;
calculating a changed collision radius and inertial information of the robot based on the change value; and
changing the driving parameter based on the calculated changed collision radius and the inertial information.

19. The robot control method of claim 16, wherein the controlling of the autonomous driving comprises controlling autonomous driving of the robot that follows a path within the space, and
the controlling of the autonomous driving comprises,
identifying a changed collision radius of the robot that varies in response to the expansion or the retraction of the sensor unit;
updating the path based on the changed collision radius; and
controlling the autonomous driving of the robot based on the updated path.
